(19) United States
(12) Patent Application Publication
(10) Pub. No.: US 2014/0326789 A1
(43) Pub. Date: Nov. 6, 2014

(54) Machine-Readable Passport With A Polycarbonate (PC) Datapage And Method For Making The same

(71) Applicant: IRIS Corporation Berhad, Kuala Lumpur (MY)

(72) Inventors: Pooi Nguon Lim, Pulau Pinang (MY); Noordazlee Bin Mohd Daud, Puchong Selangor (MY)

(21) Appl. No.: 14/356,392

(22) PCT Filed: Nov. 2, 2012
(86) PCT No.: PCT/MY2012/000267

§ 371 Date: May 5, 2014

(30) Foreign Application Priority Data
Nov. 4, 2011 (MY) PI 2011005352

(51) Int. Cl. G06K 19/02; G06K 19/077

(52) U.S. Cl. CPC G06K 19/025; G06K 19/07749
USPC 235/488

(57) ABSTRACT

The present invention provides a multi-layered personalized page comprising a PET incsti/PU hinge layer; a PC inlay with chip antenna layer with an electric component with personal data of a holder of a passport; two PC core layers with artwork; and two PC overlay layers. The present invention also provides a passport tint contains the multi-layered personalized

### FIELD OF THE INVENTION

The present invention relates to a machine-readable passport with a polycarbonate (PC) datapage laminated with an integrated hinge made of a soft and flexible fiber mesh that is sewn into a passport during the book binding process.

### BACKGROUND OF THE INVENTION

A passport is a form of booklet that is comprised of a number of sheets of paper and a cover material, each sheet having a front and a reverse side, each side comprising two pages. The sheets of paper are connected to each other along a line between the pages, attaching the cover material to an outside of the booklet, and making a fold in the sheets of paper to form a back of the booklet. Usually the sheets of paper are sewn together along the middle line.

A machine-readable passport needs to be permanently attached with a rigid plate-shaped material or assembly of materials (laminate), at least partially consisting of synthetic material. The rigid material contains IC component that allows embed personal (biographical) information and be read by a scanner; it not only expedites inspection, but also enhances the security by preventing the passport from forgery. Since the rigid material is not bendable, it cannot be sewn, stapled or folded into the passport the same way as other sheets of paper.

U.S. Pat. No. 6,213,702 discloses a method for manufacturing a booklet such as passport, where the booklet is permanently attached with a rigid plate that contains the IC component. The disclosed method comprises attaching a band in the booklet, which can be attached in the booklet in the same manner as in which the paper sheets are attached to each other, and mechanically attaching the rigid plate to the band. The connection between plate and band is of a mechanical nature allowing an almost complete freedom of choice in material of both parts. As shown in FIG. 1, the mechanical attachment is accomplished by clamping/enclosing, by providing the band 2 with perforations 9, providing a synthetic strip 8 with local projections 12, in which the synthetic strip 8 is placed on the one side of the band 2, and the plate 1 on the other side, and in which the local projections of the strip are chemically or physically connected to the plate. It is apparent that the disclosed method is complex.

U.S. Pat. No. 7,758,079 discloses a personal document in the form of a book, where the personal document comprises a book cover, a multi-layered personalized side which contains personalized data, in addition to inner pages. The personalized side and the inner pages are secured by means of a seam to the book cover. As shown in FIG. 2, the personalized page comprises a core stratum 3, two layers 24, 26 embodied as opaque white polycarbonate layers, and two laser-capable polycarbonate layers 25, 27 that are inseparably joined to the layers 24, 26 respectively. The core stratum 3 is formed from three strata 21, 22, 23, where the middle strata 21 is a textile layer made from a polyester fabric and/or a polyester satin fabric and/or a cotton fabric and/or a cotton blend fabric and/or a microfiber fabric and/or a non-woven fabric made of thermoplastic fibers; the layers 22, 23 are bonding agent layers that can be thermoplastic in nature. The core stratum 3 contains an excess length 19 that is not covered by any of the layers 24 25, 26, 27, a cut-through for disposing the RFID element 16, making the RFID element 16 an integrated part of the core stratum, and holes 28 for providing additional bonding between layers. It is to be noted that the excess length 19 of the personalized page in the area of the seam comprises only the core stratum 3, allowing the personalized page be sewn together with the paper sheets. It is evident that the making process of the core stratum is complex, requiring laminating three strata together and producing the cut-through and holes in the core stratum.

Therefore, there is a need for a simple manufacturing process for producing a multi-layered personalized data page that can be easily sewn together with paper sheets into a booklet, such as passport.

### SUMMARY OF THE INVENTION

One aspect of the present invention provides a multi-layered personalized page. In one embodiment, the multi-layered personalized page comprises a PET mesh/PU hinge layer; a PC inlay with chip antenna layer with an electric component with personal data of a holder of a passport; two PC core layers with artwork; and two PC overlay layers; wherein on one side of the PET mesh/PU hinge layer is disposed with one of the two PC core layers with artwork, and one of the two PC overlay layers sequentially; and on the other side of the PET mesh/PU hinge layer is disposed with the PC inlay with chip antenna layer, one of the two PC core layers with artwork, and one of the two PC overlay layers sequentially, so that all layers are laminated into the multi-layered personalized page; and wherein a portion of the PET mesh/PU hinge layer is not covered by any of the PC layers so that the uncovered portion forms a hinge, so that the hinge enables the multi-layered personalized page to be sewn or stapled together with paper sheets; after sewing or stapling, the hinge allows the multi-layered personalized page be folded into a booklet.

In another embodiment, the multi-layered personalized page further comprises one additional PC overlay layer that is disposed onto any of the two PC overlay layers.

Another aspect of the present invention provides a passport comprising a plurality of paper sheets and a multi-layered personalized page, wherein the paper sheets and personalized page are sewn into a booklet of the passport.

In another embodiment, the multi-layered personalized page comprises an electric component with personal data of a holder of a passport; a PET mesh/PU/PC hinge layer; two PC core layers with artwork; and two PC overlay layers; wherein on one side of the PET mesh/PU/PC hinge layer is disposed with one of the two PC core layers with artwork, and one of the two PC overlay layers sequentially, and on the other side of the PET mesh/PU/PC hinge layer is disposed with one of the two PC core layers with artwork, and one of the two PC overlay layers sequentially; and wherein the electronic component is disposed between the layers of the PET mesh/PU/PC hinge layer and any of the two PC core layers with artwork, so that all layers are laminated into the multi-layered personalized page; and wherein a portion of the PET mesh/PU/PC hinge layer is not covered by any of the PC layers so that the uncovered portion forms a hinge, so that the hinge enables the multi-layered personalized page to be sewn or stapled together with paper sheets; after sewing or stapling, the hinge allows the multi-layered personalized page be folded into a booklet.

In another embodiment of the multi-layered personalized page, the PET mesh/PU/PC hinge layer contains a plurality of cut-outs to cater for the electronic components.

The objectives and advantages of the invention will become apparent from the following detailed description of preferred embodiments thereof in connection with the accompanying drawings.

### BRIEF DESCRIPTION OF THE DRAWINGS

Preferred embodiments according to the present invention will now be described with reference to the Figures, in which like reference numerals denote like elements.

FIG. 1 shows the attachment of the rigid plate-shaped page to a booklet via a band that is mechanically connected with the rigid plate-shaped page disclosed in prior art.

FIG. 2 shows one configuration of the personalized page disclosed in the prior art.

FIG. 3 shows an illustrative cross-sectional view of the multi-layered personalized page in accordance with one embodiment of the present invention.

FIG. 4 shows an exemplary PET mesh/PU hinge layer (a), and an exemplary PC inlay with chip antenna layer (b).

FIG. 5 shows an illustrative cross-sectional view of the multi-layered personalized page in accordance with another embodiment of the present invention.

FIG. 6 shows the PET mesh/PU/PC hinge layer 210 contains a plurality of cut-outs to cater for the electronic components.

FIG. 7 shows a plain view of the finished multi-layered personalized page.

FIG. 8 shows a passport containing the multi-layered personalized page that has been sewn into the passport.

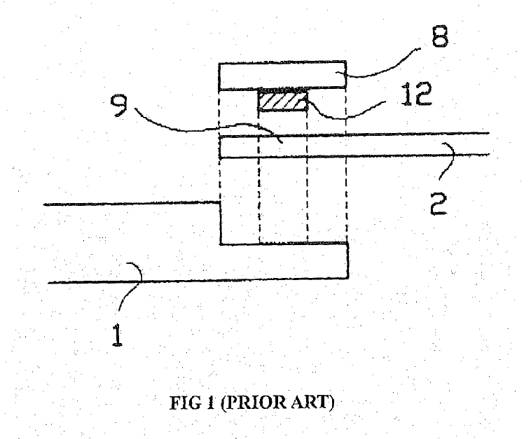

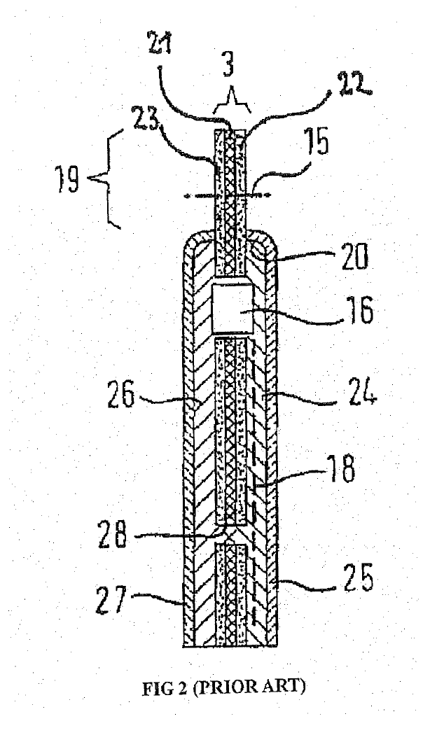

### DETAILED DESCRIPTION OF THE INVENTION

The present invention may be understood more readily by reference to the following detailed description of certain embodiments of the invention.

Throughout this application, where publications are referenced, the disclosures of these publications are hereby incorporated by reference, in their entireties, into this y describe the state of art to which this invention pertains.

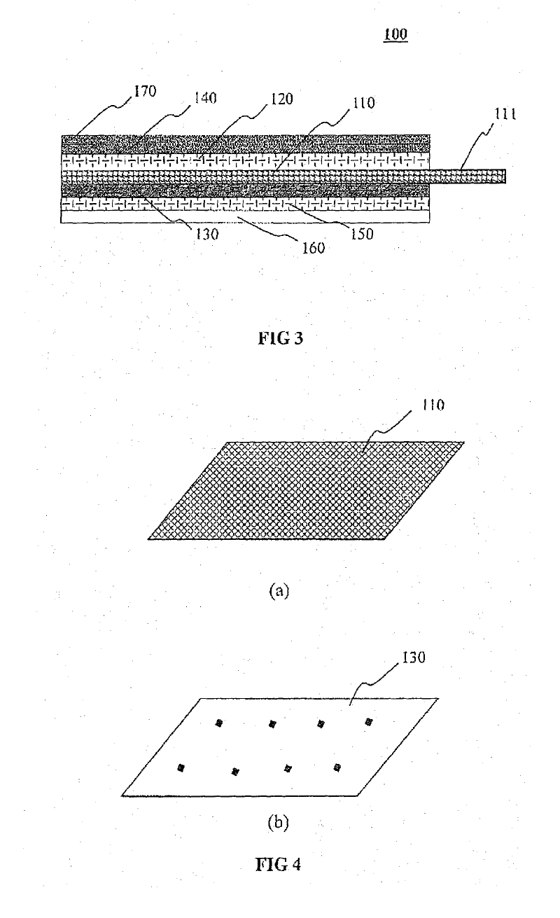

One aspect of the present invention provides a multi-layered personalized page that can be easily sewn or stapled together with paper sheets and folded into a booklet such as passport. FIG. 3 shows an illustrative dross-sectional view of the multi-layered personalized page in accordance with one embodiment of the present invention. The multi-layered personalized page 100 comprises a PET mesh/PU hinge layer 110, a PC inlay with chip antenna layer 130, two PC core layers with artwork 129, 150, and two PC overlay layers 140, 160, where on one side of the PET mesh/PU hinge layer 110 is disposed with one of the two PC core layers with artwork 120, one of the two PC overlay layers 140, and optionally one PC overlay layer 170 sequentially, and where on the other side of the PET mesh/PU hinge layer 110 is disposed with the PC inlay with chip antenna layer 130, one of the two PC core layers with artwork 150, and one of the two PC overlay layers 160 sequentially. It is to be noted that the inlay electronic components for storing and reading embedded personal data are not shown in FIG. 3 for the sake of clarity; the electronic components could be any IC board or RFID devices. As shown in FIG. 3, a portion of the PET mesh/PU hinge layer 110 is not covered by any of the PC layers so than the uncovered portion forms a hinge 111. The hinge 111 enables the multi-layered personalized page 100 to be sewn or stapled together with paper sheets; after sewing or stapling, the hinge 111 also allows the multi-layered personalized page be folded into a booklet. An exemplary PET mesh/PU hinge layer 110 is shown in FIG. 4(a), and an exemplary PC inlay with chip antenna layer 130 is shown in FIG. 4(b).

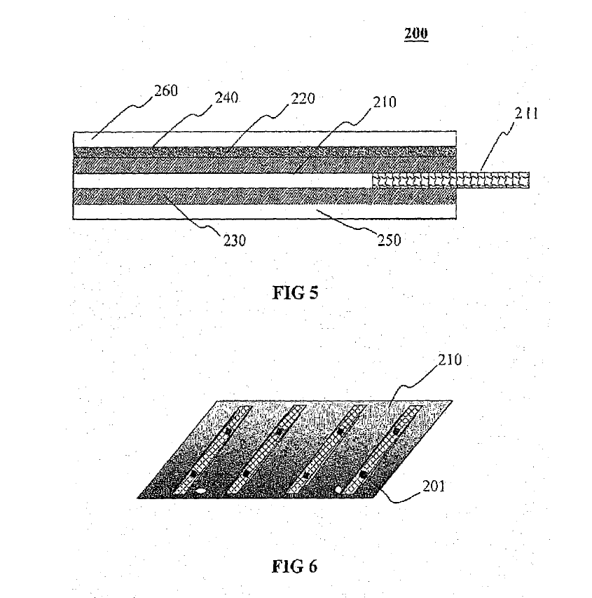

Referring now to FIG. 5, there is provided an illustrative cross-sectional view of the multi-layered personalized page in accordance with another embodiment of the present invention. The multi-layered personalized page 200 comprises a PET mesh/PU/PC hinge layer 210, two PC core layers with artwork 220, 230, and two PC overlay layers 240, 250, where on one side of the PET mesh/PU/PC hinge layer 210 is disposed with one of the two PC core layers with artwork 220, and one of the two PC overlay layers 240 sequentially, and where on the other side of the PET mesh/PU/PC hinge layer 210 is disposed with one of the two PC core layers with artwork 230, and one of the two PC overlay layers 250 sequentially. One PC overlay layer 260 is optionally disposed onto the PC overlay layer 240. It is to be noted that the inlay electronic components for storing and reading embedded personal data are not shown in FIG. 5 for the sake of clarity; the electronic components could be any IC board or RFID devices. In one embodiment, the inlay electronic components can be easily disposed between the layers of the PET mesh/PU/PC hinge layer 210 and any of the two PC core layers with artwork 220, 230. As shown in FIG. 5, a portion of the PET mesh/PU/PC hinge layer 210 is not covered by any of the PC layers so that the uncovered portion forms a hinge 211. The hinge 211 enables the multi-layered personalized page 200 to be sewn or stapled together with paper sheets; after sewing or stapling, the hinge 211 also allows the multi-layered personalized page be folded into a booklet. In another embodiment, the PET mesh/PU/PC hinge layer 210 contains a plurality of cut-outs to cater for the electronic components 201 as shown in FIG. 6, so that the hinge layer together with the electronic components is sandwiched between the two PC core layers 220, 230. The PC overlay layers 240, 250 are protective films or coatings provided protection for the personalized page, and in addition they are for laser engraving security features such as embedded hologram and MLI/CLI. The optional PC overlay layer 260 can protect the embedded hologram on the overlay layer.

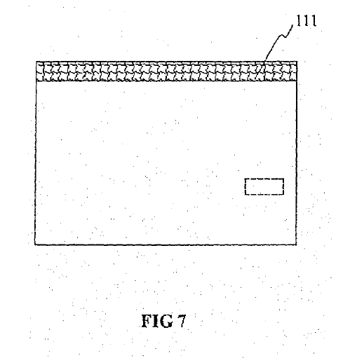

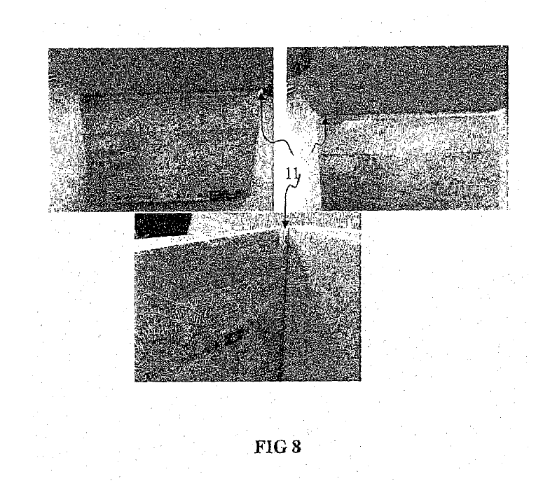

Another aspect of the present invention provides a process for manufacturing a booklet such as passport containing a rigid multi-layered personalized page. All layers are first collated using a collation jig; then the collated layers are heat-tacked together; and then the tacked layers are laminated with pressured and heated lamination plates. In one example, during lamination, the heating is 180° C./25 N/cm⁻²/40 mins, and the cooling is 18° C. /40 N/cm⁻²/20 mins. A plain view of the finished multi-layered personalized page is shown in FIG. 7. FIG. 8 shows a passport containing the multi-layered personalized page that has been sewn into the passport.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the scope of the present invention. Accordingly, the scope of the present invention is defined by the appended claims and is supported by the foregoing description.

What is claimed is:

1. A multi-layered personalized page, comprising:
a PET mesh/PU hinge layer;
a PC inlay with chip antenna layer with an electric component with personal data of a holder of a passport;
two PC core layers with artwork; and
two PC overlay layers;
wherein on one side of the PET mesh/PU hinge layer is disposed with one of the two PC core layers with artwork, and one of the two PC overlay layers sequentially; and on the other side of the PET mesh/PU hinge layer is disposed with the PC inlay with chip antenna layer, one of the two PC core layers with artwork, and one of the two PC overlay layers sequentially, so that all layers are laminated into the multi-layered personalized page; and
wherein a portion of the PET mesh/PU hinge layer is not covered by any of the PC layers so that the uncovered portion forms a hinge, so that the hinge enables the multi-layered personalized page to be sewn or stapled together with paper sheets; after sewing or stapling, the hinge allows the multi-layered personalized page be folded into a booklet.

2. The multi-layered personalized page of claim 1, further comprising one additional PC overlay layer that is disposed onto any of the two PC overlay layers.

3. A passport comprising a plurality of paper sheets and a multi-layered personalized page of claim 1, wherein the paper sheets and personalized page are sewn into a booklet of the passport.

4. A multi-layered personalized page, comprising:
an electric component with personal data of a holder of a passport;
a PET mesh/PU/PC hinge layer;
two PC core layers with artwork; and
two PC overlay layers;
wherein on one side of the PET mesh/PU/PC hinge layer is disposed with one of the two PC core layers with artwork, and one of the two PC overlay layers sequentially, and on the other side of the PET mesh/PU/PC hinge layer is disposed with one of the two PC core layers with artwork, and one of the two PC overlay layers sequentially; and
wherein the electronic component is disposed between the layers of the PET mesh/PU/PC hinge layer and any of the two PC core layers with artwork, so that all layers are laminated into the multi-layered personalized page; and
wherein a portion of the PET mesh/PU/PC hinge layer is not covered by any of the PC layers so that the uncovered portion forms a hinge, so that the hinge enables the multi-layered personalized page to be sewn or stapled together with paper sheets; after sewing or stapling, the hinge allows the multi-layered personalized page be folded into a booklet.

5. The multi-layered personalized page of claim 4, further comprising one additional PC overlay layer that is disposed onto any of the two PC overlay layers.

6. The multi-layered personalized page of claim 4, wherein the PET mesh/PU/PC hinge layer contains a plurality of cut-outs to cater for the electronic components.

7. A passport comprising a plurality of paper sheets and a multi-layered personalized page of claim 4, wherein the paper sheets and personalized page are sewn into a booklet of the passport.
